(19) United States
(12) Patent Application Publication
(10) Pub. No.: US 2015/0152716 A1
(43) Pub. Date: Jun. 4, 2015

(54) Method, System and Apparatus of Erosion Resistant Filtering Screen Structures

(71) Applicants: Namhyo Kim, Houston, TX (US); David Underdown, Conroe, TX (US); Thomas Gary Corbett, Willis, TX (US); Antonio Lazo, Houston, TX (US); Luis Phillipe Costa Ferreira Tosi, Houston, TX (US); Earl B. Claiborne, JR., Kemah, TX (US)

(72) Inventors: Namhyo Kim, Houston, TX (US); David Underdown, Conroe, TX (US); Thomas Gary Corbett, Willis, TX (US); Antonio Lazo, Houston, TX (US); Luis Phillipe Costa Ferreira Tosi, Houston, TX (US); Earl B. Claiborne, JR., Kemah, TX (US)

(73) Assignee: Chevron U.S.A. Inc., San Ramon, CA (US)

(21) Appl. No.: 14/095,487

(22) Filed: Dec. 3, 2013

(51) Int. Cl. E21B 43/08; B01D 29/56

(52) U.S. Cl. CPC E21B 43/088; B01D 29/56

(57) ABSTRACT

An improved particle or sand filtering apparatus, method and system is disclosed. The apparatus may be adapted to filter particles or sand from a particle-laden hydrocarbon fluid by employing a stacked multi-layered screen in an X-Y plane and having at least one screen comprised of a plurality of first wires and a plurality of second wires that are woven. The stacked screen may be placed within a production tubing in a wellbore for the production of hydrocarbons from the wellbore. The apparatus is configured to facilitate passage of particle-laden fluid through the screen in a direction that is substantially parallel to an X-Y plane of the screen.

### FIELD OF THE INVENTION

The field of the invention relates to structures adapted for filtering particulates from a flowing fluid.

### BACKGROUND OF THE INVENTION

Sand exclusion screens are employed in wellbores during the production of hydrocarbon fluids from subterranean formations. Such screens are designed to filter out particles, such as sand or rock particles, while facilitating the passage of hydrocarbon fluids into the wellbore. One problem in the deployment of such screens is the erosion of the screens by collision of particles upon the screen. High flow rates, coupled with large amounts of particulate in the flow stream, causes erosion. When screens become eroded, then particles are produced from the well, which is highly undesirable.

Removing large amounts of sand particles from produced hydrocarbon fluids is expensive, time consuming, and costly. In many applications for deep wellbores, the financial cost of installing sand exclusion equipment is very high. The time and effort required to install screens into wellbores is a limiting factor in the economic viability of a producing well. In some instances, it is impossible, physically or economically, to re-enter a deep wellbore to remove and replace eroded screens.

The hydrocarbon production industry needs improved screen designs, systems and methods to filter particles of sand from production fluids for many years, without excessive and undesirable erosion of the screens. This invention is directed to improved apparatus, systems and methods for such applications.

### BRIEF DESCRIPTION OF THE FIGURES

The FIGS. 1-2A show prior art structures, while FIGS. 3A-19 illustrate various aspects of the invention, wherein:

FIG. 1 illustrates a conventional prior art sand exclusion screen that has been eroded by impact of particles with the screen;

FIG. 2 is a simplified schematic showing movement of particles through the weave of a conventional prior art sand exclusion screen, resulting in erosion of the screen;

FIG. 2A illustrates prior art multi-layered screens that are configured to accept fluid flowing perpendicularly through the screen in the Z direction, at right angles to the X-Y plane of the woven screen, which causes undesirable erosion and plugging of screens with particulates;

FIG. 3A illustrates how changing the shape of a wire in the practice of the invention, can, if oriented in an appropriate manner, form a streamlined velocity field near the wire surface and reduce the impact of the particles to the wire surface, in one aspect of the invention;

FIG. 3B illustrates a magnified view of a screen woven in an X-Y plane (warp/weft), in which flow of particulate-laden fluid through the screen is generally parallel to the X-Y plane (as opposed to in the Z plane), wherein wires from the warp and weave of a screen interlock in one aspect of the invention, and in which the average velocity of the particle is reduced by passage along the long dimension of an elongated, oval-shaped wire of the plurality of first wires, and further shows a smooth particle path passing along elongated oval shaped wires in one aspect of the invention, wherein the average velocity of the particle may be reduced near the surface of the wire compared to that velocity that would occur near a round-shaped wire, and the particle velocity may be even more reduced as the particle is relaxed in the downstream region before the particle reaches the next wire in the warp direction;

FIG. 4 illustrates a cross-sectional schematic of a stacked wire screen wherein flow passes through the cross-section of the stacked wire screen in the X-Y plane;

FIG. 5 shows schematically one manner of weaving wires together to form a single layer of mesh;

FIG. 6A reveals an example of a wire that is oval in cross section, with a long dimension and a short dimension;

FIG. 6B shows a wire that is rectangular in cross section, with a long dimension and a short dimension;

FIG. 7 illustrates a manufactured wire screen, in which the manner of manufacture of a weaved screen facilitates the screen to be cut into strips, rotated, and re-assembled to provide an improved orientation for reduced erosion effect;

FIG. 8 illustrates the cutting of the screen of FIG. 7, followed by ninety degree rotation of the cut screen portions, which may be accomplished to orient oval-shaped wires with the long dimension in the direction of particulate-laden fluid flow;

FIG. 9 illustrates a re-bonded stacked wire screen of FIG. 8 that exhibits the preferred orientation of the wires, with the long dimension of the wires running parallel to the direction of fluid flow path through the screen, and with the fluid/particle flow direction through the re-bonded screen illustrated;

FIG. 10 shows the screen of FIG. 9 applied into a tubular screen structure;

FIG. 11 illustrates a tubular woven screen positioned concentrically between an inner perforated tubing and outer screen housing;

FIG. 12 illustrates a screen having a relatively long pitch, with circular wires running in one direction (from left to right in the Figure);

FIG. 13 shows another embodiment of the invention having a relatively long pitch with wires of oval cross section in both the warp and weft directions, and additionally;

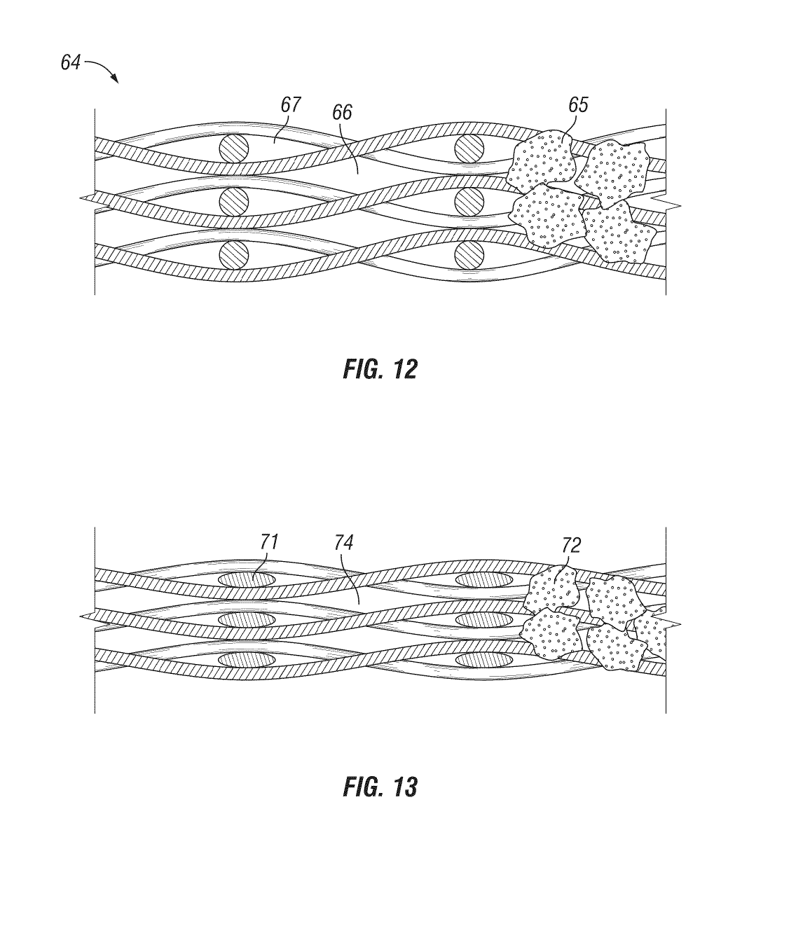

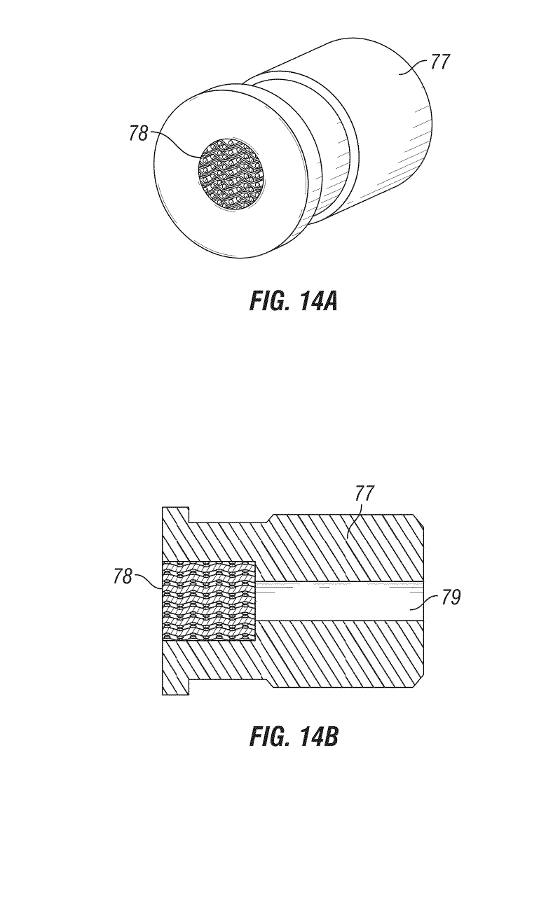

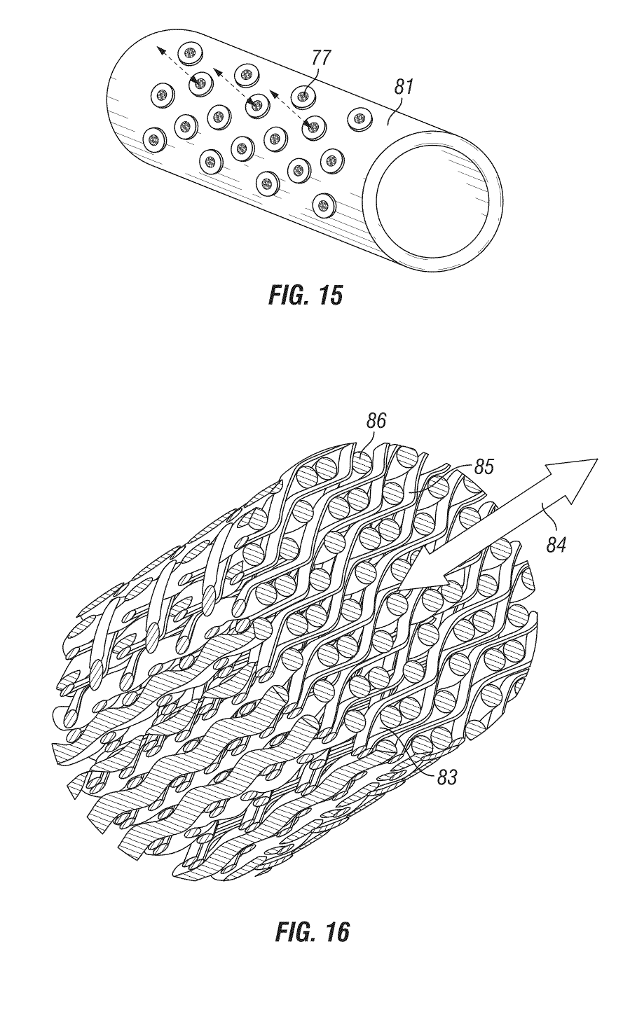

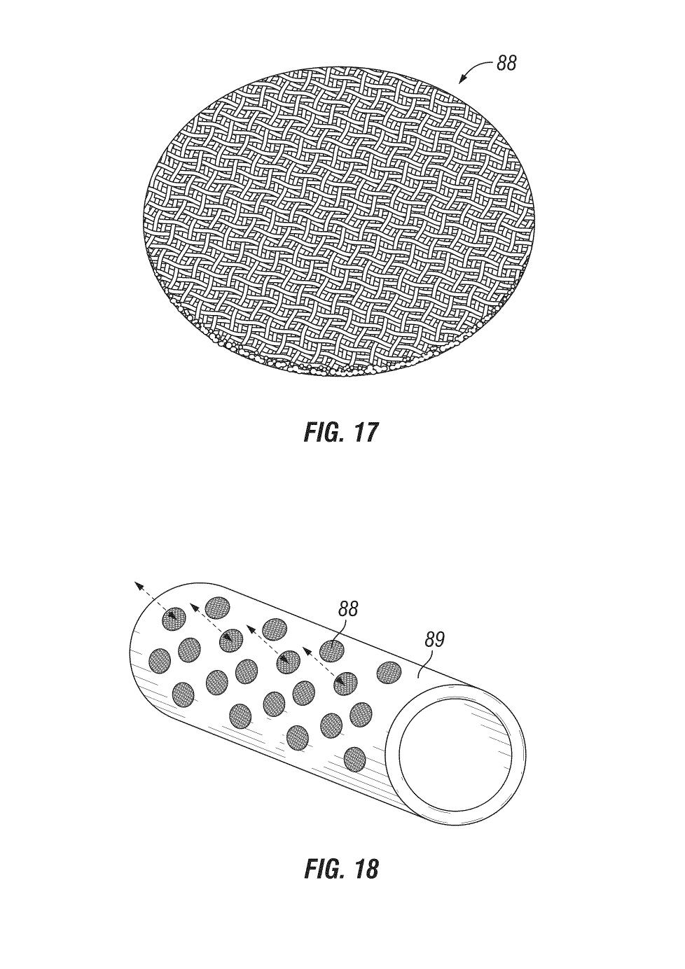

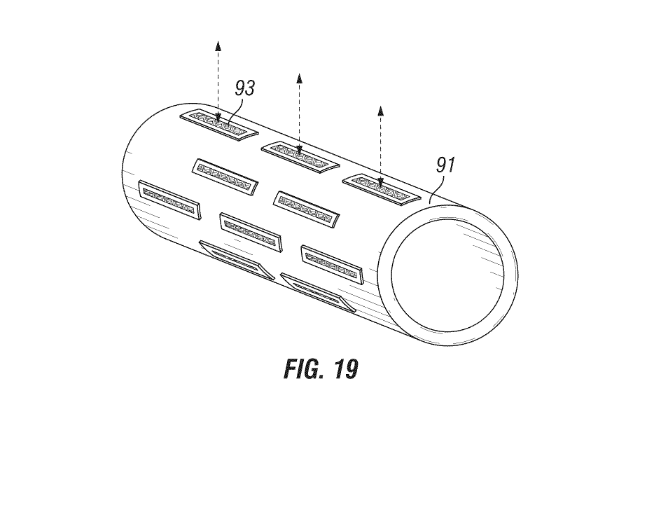

FIGS. 12-13 illustrate the manner in which in one aspect of invention it is possible to adjust the particle filtering gap and porosity by changing the size, shape and weft-direction spacing of the wires running in the warp direction;

FIG. 14A illustrates an embodiment of the invention that employs a stacked screen inside of a capsule adapted for insertion of the capsule into a slot within a production tubing, which preferably provides the screen with X-Y plane aligned in the same direction as fluid flow through the screen;

FIG. 14B shows a cross-section of the capsule, with flow channel for flow of particle-laden fluid through the capsule;

FIG. 15 shows a slotted production tubing that receives the capsule of FIG. 14B;

FIG. 16 illustrates in perspective view a stacked screen that is suitable for filtering a hydrocarbon flow stream, with the X-Y plane aligned with the direction of fluid flow 84;

FIG. 17 illustrates a stacked screen button that may be deployed in a production tubing in one aspect of the invention;

FIG. 18 shows a perforated production tubing that is capable of receiving the button shown in FIG. 17; and

FIG. 19 illustrates an alternate configuration of a production tubing having rectangular slots to receive a rectangular-shaped button of stacked screen material.

### SUMMARY

A filtering apparatus may be adapted to filter particles from a flowing fluid. The apparatus comprises a plurality of screens applied together. The plurality of screens comprises: (a) a first screen comprised of a plurality of first wires and a plurality of second wires, the pluralities of first and second wires being weaved, (b) the plurality of first wires being oriented generally parallel to each other in an X direction, (c) the plurality of second wires being oriented generally parallel to each other in a Y direction, wherein the X direction and Y direction are oriented substantially perpendicular to each other, thereby forming an X-Y two dimensional plane; and (d) the first screen being configured for receiving and filtering a particle-laden fluid flowing through the screen in a flow direction that is substantially parallel to the X-Y two dimensional plane.

Optionally, in some applications, the wires of the plurality of first wires each comprise a long dimension and a short dimension defining a cross-sectional profile, the long dimension being greater than the short dimension, wherein the long dimension of the plurality of first wires is oriented in the X-Y plane in parallel to the direction of flow of the particle-laden fluid, such that the plurality of first wires present to the particle-laden fluid a reduced particle impact area.

In some applications, the plurality of screens applied together is between about 2 and about 50 screens, but it will depend upon the particular application. However, it is recognized that a larger or smaller number of screens may be applied together. For some applications of the invention, the filtering apparatus is tubular shaped. In other applications, the filtering apparatus is positioned concentrically outside of a perforated tubing. In yet other applications, the filtering apparatus may be positioned within a capsule or button, the capsule or button being adapted for insertion into a slot within a production tubing.

The invention also may be characterized in a system for filtering particles from hydrocarbon fluids produced from a wellbore. The system may comprise:

a wellbore extending into a subterranean formation,

a production tubing positioned within the wellbore, the production tubing being configured for facilitating the passage of hydrocarbon fluids into the tubing for passage through the well, the production tubing being configured for retarding the passage of particulates, the production tubing being in fluid communication with an apparatus adapted to filter particles from a flowing fluid,

the apparatus comprising a plurality of screens stacked together, wherein the first screen comprises a plurality of first wires and a plurality of second wires, the pluralities of first and second wires being weaved, the plurality of first wires being oriented generally parallel to each other in an X direction,

the plurality of second wires being oriented generally parallel to each other in a Y direction, wherein the X direction and the Y direction are oriented substantially perpendicular to each other, thereby forming an X-Y two dimensional plane,

the first screen being configured for receiving and filtering a particle-laden fluid flowing through the screen in a flow direction that is substantially in parallel to the X-Y two dimensional plane,

the wires of the plurality of first wires each comprising a long dimension and a short dimension defining a cross-sectional profile, the long dimension being greater than the short dimension, and wherein the long dimension of the plurality of first wires is oriented in the X-Y plane in parallel to the direction of flow of the particle-laden fluid, such that the plurality of first wires present to the particle-laden fluid a reduced particle impact area.

Other applications of the invention may include a method of filtering particles from particle-laden hydrocarbon fluids flowing into a wellbore. In the method, the wellbore may extend downward into a subterranean formation. Such a method may include the steps of: (a) providing a production tubing positioned within the wellbore, the production tubing being configured for facilitating passage of hydrocarbon fluids into the production tubing, the production tubing being configured for retarding passage of particulates into the production tubing, the production tubing being in fluid communication with a stacked multi-layered screen structure, wherein at least one screen in the stacked multi-layered screen structure comprises a plurality of first wires and a plurality of second wires, the pluralities of first and second wires being woven, the plurality of first wires being oriented generally parallel to each other, and in a first X direction, the plurality of second wires being oriented generally parallel to each other, and in a second Y direction, wherein the X direction and Y direction are oriented substantially perpendicular to each other and form an X-Y two-dimensional plane, (b) flowing the particle-laden fluid through the screen substantially parallel to the X-Y two-dimensional plane, and (c) filtering particles from the particle-laden fluid.

Some applications of the method will include wires of the plurality of first wires each comprising a long dimension and a short dimension defining a cross-sectional profile, the long dimension being greater than the short dimension, wherein the long dimension of the plurality of first wires is oriented in the X-Y plane in parallel to the direction of flow of the particle-laden fluid, such that the plurality of first wires present to the particle-laden fluid a reduced particle impact area.

### DETAILED DESCRIPTION

The invention provides a sand control screen that is more resistant to erosion than conventional sand control screens. By limiting erosion loss, it is not required to hold back the rate of oil and gas production, which is common in instances of sand screen erosion. This facilitates an increase in the oil and gas production rate.

In the present invention, the screen is applied in multiple stacked configuration to a thickness that is desirable for a given application. An example of a thickness that may be useful is between about ⅜ inches and about ½ inches in total thickness, but it is recognized that larger or smaller total thickness may be employed as well. The required number of screens may be about 2 to about 50 to build the necessary thickness, depending upon the particular application.

The screen design of the invention employs a plurality of stacked screens as the filtering space by flowing particulate-laden hydrocarbon fluids between the screen layers, and by using the controlled space between the layers (a by-product of the weave) as the filtering gap. During the construction of each wire mesh screen, the wire element (either warp or weft direction) that will be facing particulate laden fluid preferably may have, in one embodiment, a streamlined cross-sectional shape to reduce erosion loss by collision with solid particulates in the flow stream.

The oval shape of a wire (in cross section) is not necessarily required in the invention, but is one option. Another option is to provide an oval shaped wire in both the X and Y directions. In a broad embodiment of the invention, however, circular cross section (i.e. round) wires in both the X and Y direction can be employed, with no oval shaped wires used.

As to the weaving method employed, there is no limit to the type of weave that may be used. Square weave, dutch twill, reverse dutch twill or other weaving methods may be employed in the construction of the weave of the invention.

In addition, the multiplicity of filtering gaps in the direction of flow can significantly prolong the erosion life of the screen. Furthermore, the homogenous distribution of large opening flow area within the media volume facilitates the plugging control of the screen.

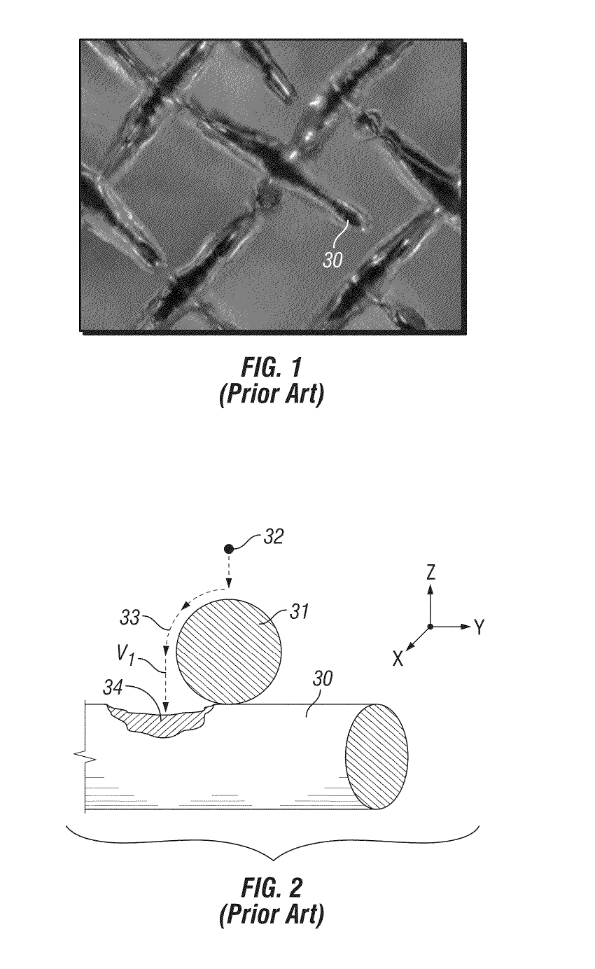

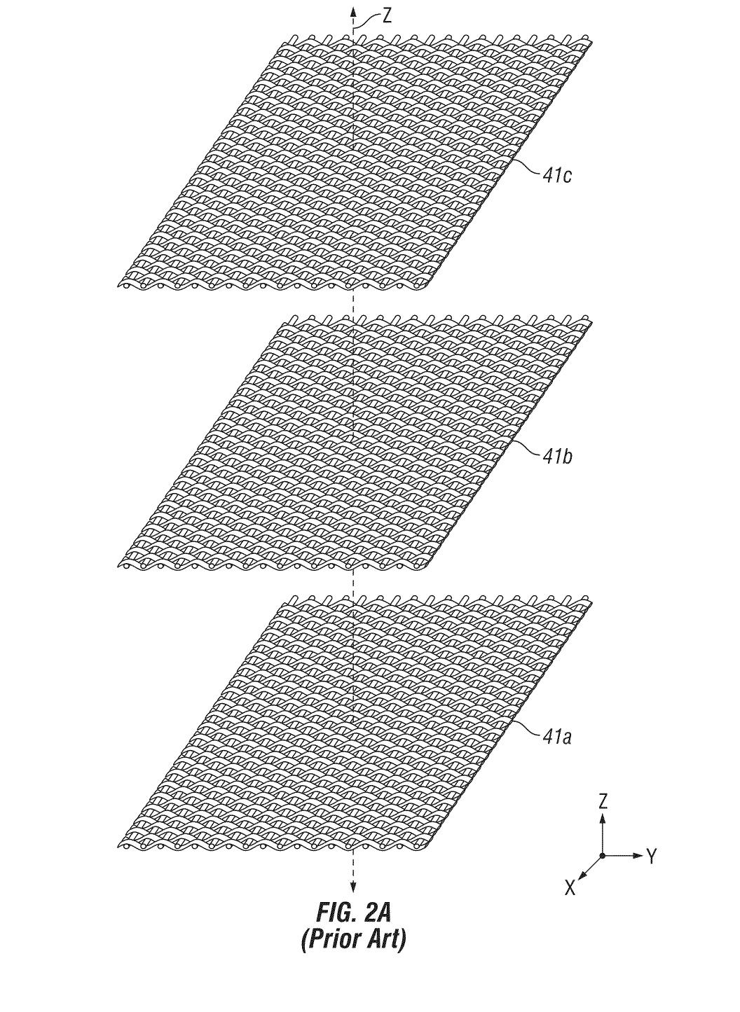

With reference to the Figures, FIG. 1 illustrates a conventional sand control device with an eroded screen, showing, for example, eroded wire 30. FIG. 2 illustrates schematically the mechanism of erosion, showing eroded wire 30. Cross wire 31 receives a particle 32, which travels around the periphery of cross wire 31 along particle path 33 at velocity V1, which may be about two times faster than the incoming fluid stream velocity. The impact of particles such as particle 32 causes eroded region 34 of wire 30.

FIG. 2A illustrates prior art multi-layered screens of screens 41a, 41b, and 41c, wherein fluid flows in the Z direction, perpendicular to the X-Y plane of the screen, which may cause undesirable erosion and plugging of screens with particulate matter.

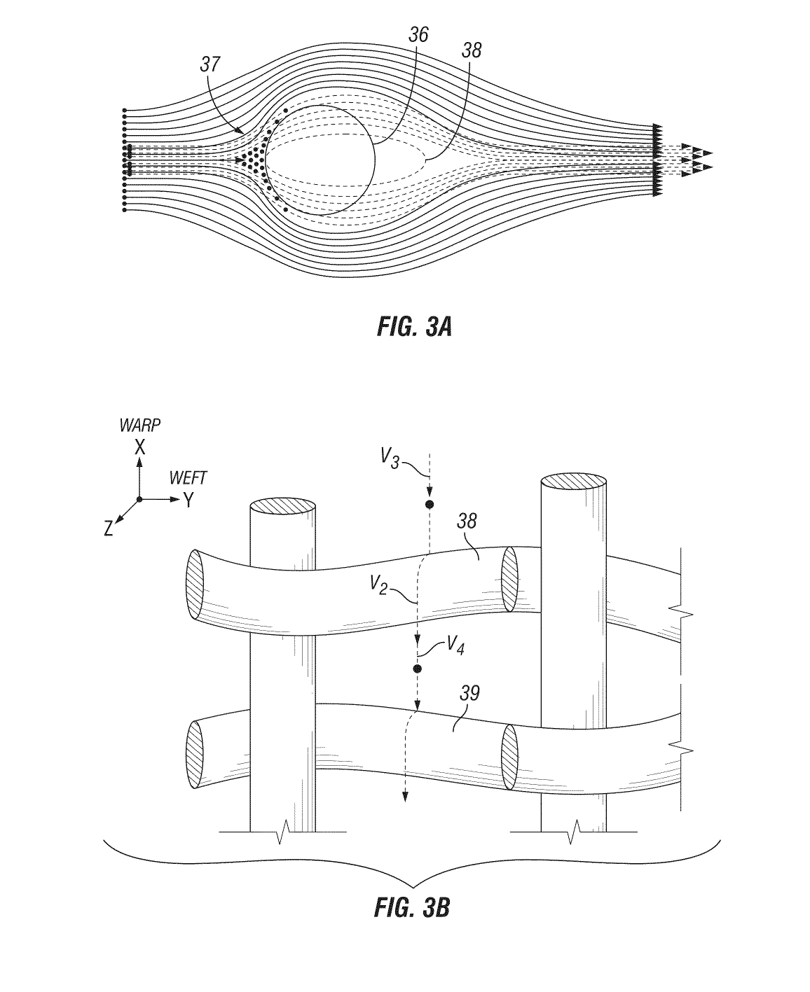

FIG. 3A illustrates the manner in which one may employ, in one embodiment, a shaped wire in the practice of the invention, compared to conventional screen structures. If oriented properly, a shaped wire may reduce the velocity of impact of the particles on adjacent wires in the screen. A conventional round wire 36 is shown receiving particles 37, which impact wire 36. A wire 38 with reduced particle impact area is shown as well.

FIG. 3B illustrates the particle impact area wherein wires from the warp and weave of a screen interlock in one aspect of the invention in which the average velocity of the particle is reduced by passage along the long dimension of an elongated, oval shaped wire 38 of the plurality of first wires. The average velocity of the particle may be reduced near the surface of the wire compared to that velocity that would be experienced adjacent a round shaped wire, and the particle velocity may be even more reduced as the particle is relaxed in the downstream before the particle reaches the next oval shaped wire 39 in the warp direction.

In FIG. 3B, this magnified view illustrates a screen woven in an X-Y plane (warp/weft), in which flow of particulate-laden fluid through the screen is generally parallel to the X-Y plane of the screen. Thus, the performance of the screen is improved by in this embodiment of the invention by both: (1) flowing the particle laden fluid generally parallel to the X-Y plane, instead of in the Z plane as in the prior art conventional screens, and also (2) by the deployment of oval shaped wires 38, 39. Both of these features may be deployed, and in other instances, only one or the other feature may be deployed.

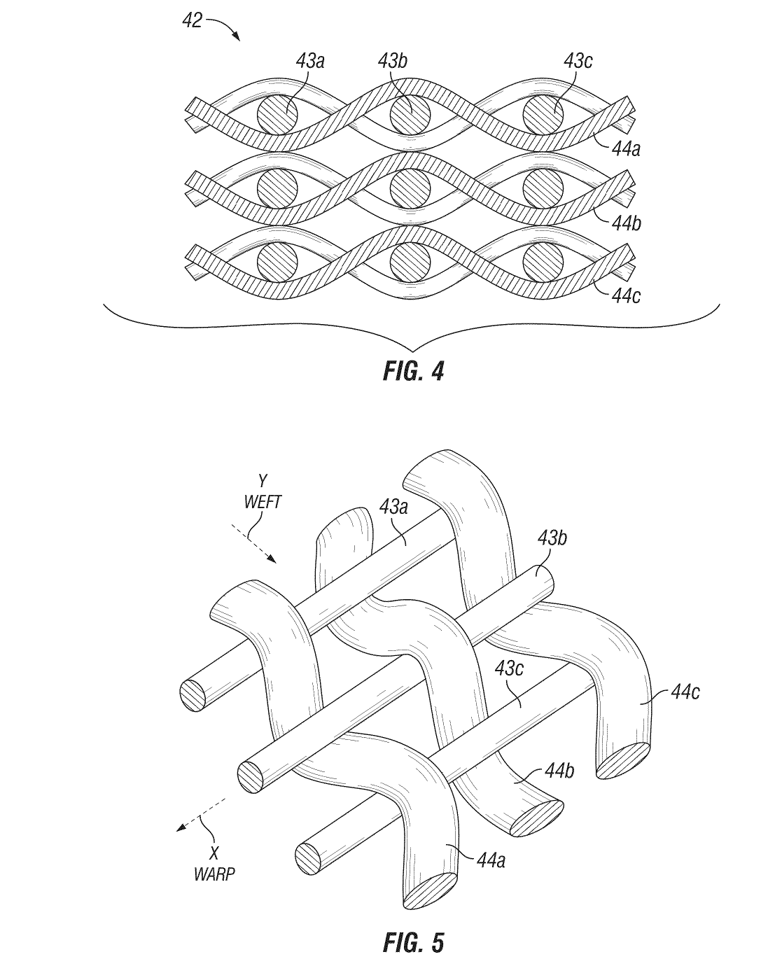

FIG. 4 illustrates a stacked wire screen in one aspect of the invention. First woven screen 42 is comprised of wires 43a, 43b and 43c in the warp direction, and wires 44a, 44b, and 44c in the weft direction.

FIG. 5 illustrates one manner of weaving such wires together to form a screen, with warp and weft directions shown.

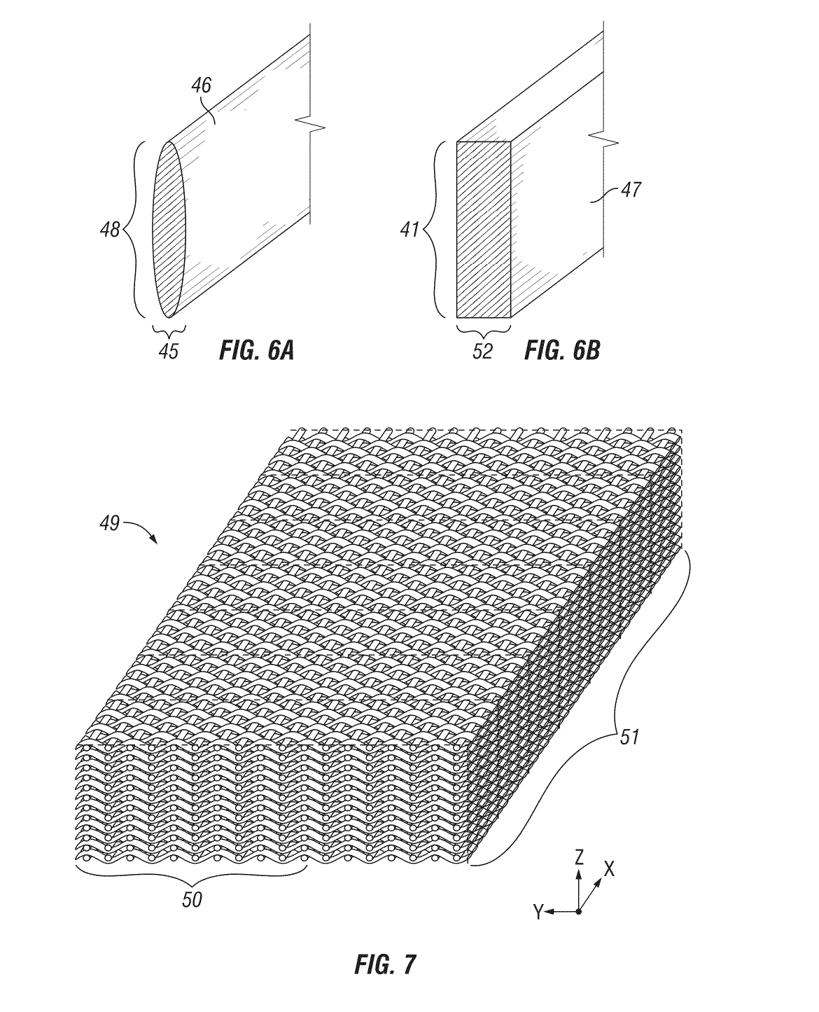

FIG. 6A reveals an example of a wire 46, with reduced particle impact area that is oval in cross section, with a long dimension 48 and a short dimension 45. FIG. 6B shows a wire 47, with reduced particle impact area that is substantially rectangular in cross section, with a long dimension 41 and a short dimension 52.

FIG. 7 illustrates a manufactured stacked wire screen 49, in which the manner of manufacture of a weaved screen facilitates the screen to be cut into strips, rotated, and re-assembled to provide an improved orientation for reduced erosion effect. Depending upon the application, the wires used may be circular in cross section in both X and Y directions. In another aspect of invention, cut ends 50 may be round in cross-section, while cut ends 51 are oval in cross-section.

In FIG. 7, the cut ends facing 51 may be oval in cross section, with the long dimension running parallel with the X direction, as shown in the FIG. 7. The desirable main flow direction is parallel to the X direction in FIG. 7.

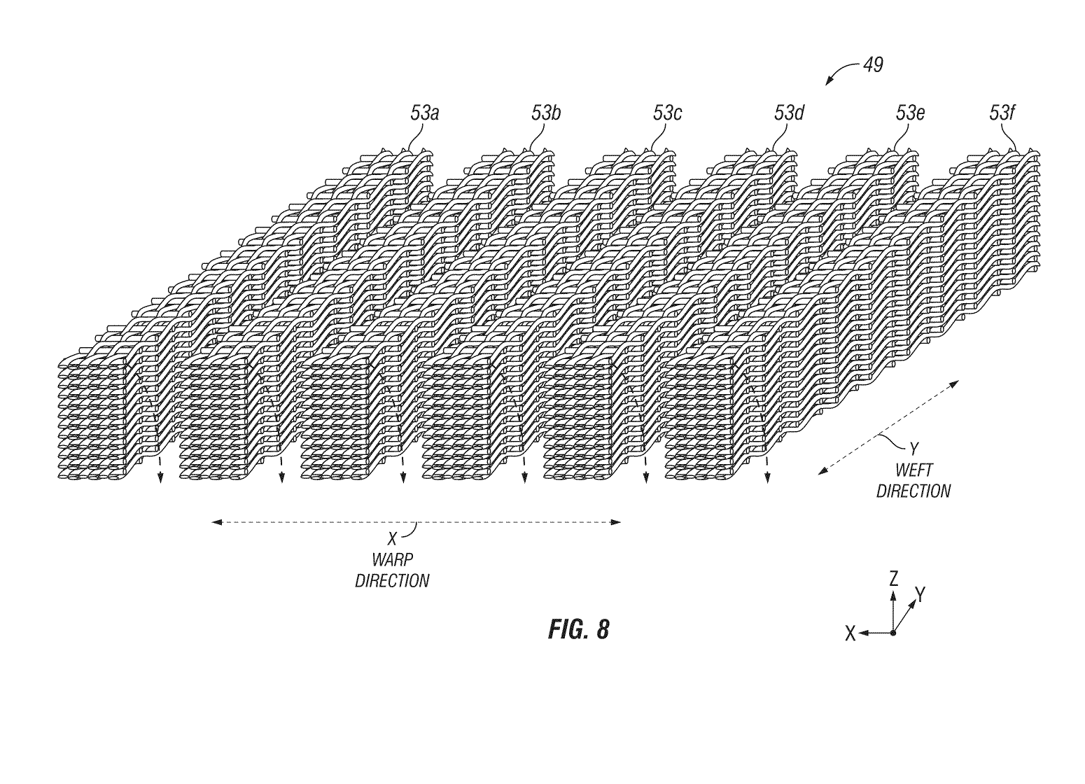

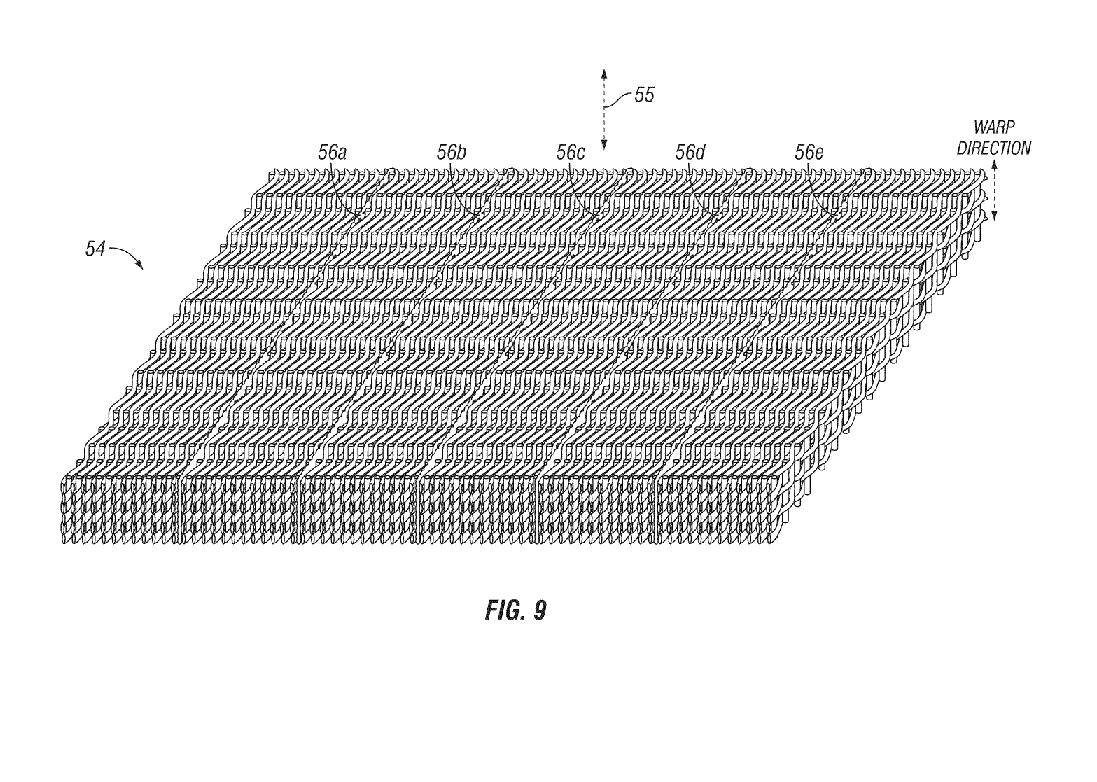

FIG. 8 illustrates a manufacturing technique in one embodiment of the invention, which includes a particular manner of improving the flow characteristics by cutting a stacked wire screen 49 as in FIG. 7, followed by ninety degree rotation of the cut portions. Cut screen sections 53a-f may be severed from each other by a cutting machine (not shown), and then rotated and re-attached to form a re-bonded stacked wire screen 54, as shown in FIG. 9. In FIG. 8, the X, Y, Z directions can be seen, and the X-Y plane runs horizontal in the FIG. 8.

Rebond seams 56a-e are illustrated in FIG. 9, and such seams 56a-e may be formed by heating or other metal bonding technique. As shown in FIG. 9, the cut ends 51 with oval cross-section running in the warp direction are configured to expose the elongated profile of the wires in the most advantageous position with respect to the direction 55 of flowing particle-laden fluid. The long dimension may be oriented parallel to the direction 55. Then, the stacked wire screen 54 may be configured to have an advantageous wire orientation. Fluid/particle flow direction through the rebounded screen is seen in FIG. 9. This re-bonded screen orients the long dimension of the wires parallel to the direction of fluid/particle flow.

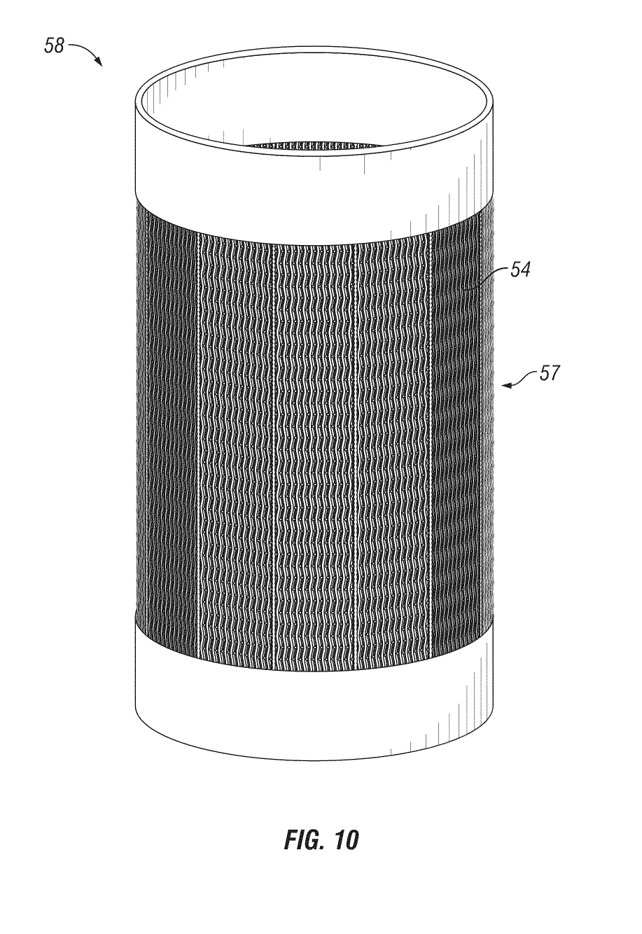

In FIG. 10, the stacked wire screen 54 of FIG. 9 is illustrated rolled into a tubular screen 58, with wires having an elongated cross-section (as an example) embedded within the screen to reveal the long dimension oriented in parallel to the fluid flow path 57. Also, the screen is provided so that the X-Y plane is provided in alignment in the same direction as fluid flow, which may reduce erosion of the wires.

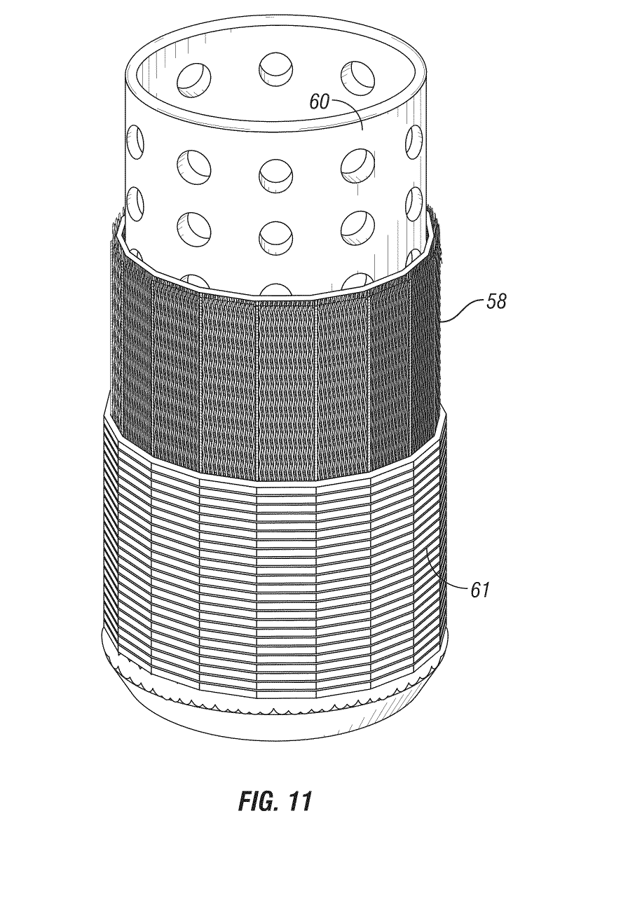

FIG. 11 illustrates a completed sand screen filtering apparatus, which contains the tubular screen 58 of FIG. 10 positioned concentrically between an inner perforated tubing 60 and a screen housing 61.

FIG. 12 illustrates a further embodiment of the invention with circular cross wires in the weft direction. A stacked wire screen 64 having a relatively large gap spaces 66, 67 for filtering of designated sand particle size 65, which is desirable for some applications.

FIG. 13 illustrates yet another embodiment of the invention with elliptical (oval) cross wires 71. Sand particle 72 is inhibited from entry, due in part to gap space 74, which is reduced. The control of the gap spacing and porosity of the screen to sand entry may be achieved by weave pitch and wire size or/shape.

FIG. 14A shows one embodiment of the invention that employs a stacked wire screen 78 mounted inside a capsule 77, for insertion of capsule 77 into a slot within a production tubing. FIG. 14B shows a cross-section of the capsule 77, with flow channel 79 for flow of particle laden fluid through the capsule 77. In one embodiment, the stacked screen is deployed into capsule 77 so that the X-Y plane of the screen weave is in alignment with the direction of particulate-laden fluid flow, to reduce erosion.

FIG. 15 shows a slotted production tubing 81 that receives capsule 77, previously shown in FIG. 14.

FIG. 16 illustrates in perspective view a stacked wire screen 83 that is suitable for filtering a hydrocarbon flow stream. Flow direction 84 for a particle-laden fluid is shown, which runs parallel to the elongated dimension of oval shaped wire 85. Oval shaped wire 85 is perpendicular to circular wire 86.

FIG. 17 illustrates one embodiment of the invention that employs a stacked screen button 88. The button 88 may be inserted (as shown in FIG. 18) into a perforated production tubing 89, and it functions to filter particle-laden fluid flowing through the button 88.

FIG. 19 illustrates an alternate configuration, with a production tubing 91 having rectangular slots 93 that are configured to receive a rectangular shaped portion of stacked screen material.

Other embodiments of the invention not specifically disclosed but within the scope of this disclosure also could be employed in the practice of the invention. Other wires shapes and cross-sectional configurations of the invention not specifically disclosed but within the spirit of this disclosure also could be employed in the practice of the invention.

We claim:

1. A filtering apparatus adapted to filter particles from a flowing fluid, the apparatus comprising a plurality of screens applied together, the plurality of screens comprising:
(a) a first screen comprised of a plurality of first wires and a plurality of second wires, the pluralities of first and second wires being weaved,
(b) the plurality of first wires being oriented generally parallel to each other in an X direction,
(c) the plurality of second wires being oriented generally parallel to each other in a Y direction, wherein the X direction and Y direction are oriented substantially perpendicular to each other, thereby forming an X-Y two dimensional plane; and
(d) the first screen being configured for receiving and filtering a particle-laden fluid flowing through the screen in a flow direction that is substantially parallel to the X-Y two dimensional plane.

2. The filtering apparatus of claim 1 further wherein:
the wires of the plurality of first wires each comprise a long dimension and a short dimension defining a cross-sectional profile, the long dimension being greater than the short dimension,
wherein the long dimension of the plurality of first wires is oriented in the X-Y plane in parallel to the direction of flow of the particle-laden fluid, such that the plurality of first wires present to the particle-laden fluid a reduced particle impact area.

3. The apparatus of claim 1 wherein the plurality of screens applied together comprises between about 2 and about 50 screens.

4. The apparatus of claim 1 wherein the filtering apparatus is tubular shaped.

5. The apparatus of claim 4 wherein the filtering apparatus is positioned concentrically outside of a perforated tubing in the filtering apparatus.

6. The apparatus of claim 1 wherein the filtering apparatus is positioned within a capsule, the capsule being adapted for insertion into a slot within a production tubing.

7. The apparatus of claim 1 wherein the filtering apparatus is provided in a button, the button being adapted for insertion into a slot within a production tubing.

8. The apparatus of claim 7 wherein the button is rectangular-shaped.

9. A system for filtering particles from hydrocarbon fluids produced from a wellbore, the system comprising:
a wellbore extending into a subterranean formation,
a production tubing positioned within the wellbore, the production tubing being configured for facilitating the passage of hydrocarbon fluids into the tubing for passage through the well, the production tubing being configured for retarding the passage of particulates, the production tubing being in fluid communication with an apparatus adapted to filter particles from a flowing fluid,
the apparatus comprising a plurality of screens stacked together, wherein the first screen comprises a plurality of first wires and a plurality of second wires, the pluralities of first and second wires being weaved, the plurality of first wires being oriented generally parallel to each other in an X direction,
the plurality of second wires being oriented generally parallel to each other in a Y direction, wherein the X direction and the Y direction are oriented substantially perpendicular to each other, thereby forming an X-Y two dimensional plane, and
the first screen being configured for receiving and filtering a particle-laden fluid flowing through the screen in a flow direction that is substantially in parallel to the X-Y two dimensional plane.

10. A method of filtering particles from particle-laden hydrocarbon fluids flowing into a wellbore, the wellbore extending downward into a subterranean formation, the method comprising the steps of:
(a) providing a production tubing positioned within the wellbore, the production tubing being configured for facilitating passage of hydrocarbon fluids into the production tubing, the production tubing being configured for retarding passage of particulates into the production tubing, the production tubing being in fluid communication with a stacked multi-layered screen structure, wherein at least one screen in the stacked multi-layered screen structure comprises a plurality of first wires and a plurality of second wires, the pluralities of first and second wires being woven, the plurality of first wires being oriented generally parallel to each other, and in a first X direction, the plurality of second wires being oriented generally parallel to each other, and in a second Y direction, wherein the X direction and Y direction are oriented substantially perpendicular to each other and form an X-Y two-dimensional plane,
(b) flowing the particle-laden fluid through the screen substantially parallel to the X-Y two-dimensional plane, and
(c) filtering particles from the particle-laden fluid.

11. The method of claim 10 further wherein the wires of the plurality of first wires each comprise a long dimension and a short dimension defining a cross-sectional profile, the long dimension being greater than the short dimension, wherein the long dimension of the plurality of first wires is oriented in the X-Y plane in parallel to the direction of flow of the particle-laden fluid, such that the plurality of first wires present to the particle-laden fluid a reduced particle impact area.
